(19) United States
(12) Patent Application Publication
(10) Pub. No.: US 2012/0241437 A1
(43) Pub. Date: Sep. 27, 2012

(54) LASER PROCESSING WORK TABLE

(76) Inventor: Il-Young JEONG, Yongin-City (KR)

(21) Appl. No.: 13/370,577

(22) Filed: Feb. 10, 2012

(30) Foreign Application Priority Data
Mar. 23, 2011 (KR) 10-2011-0025880

(51) Int. Cl. H05B 3/68

(52) U.S. Cl. 219/443.1

(57) ABSTRACT

A laser processing work table for processing a substrate by using a laser beam includes a base plate; a plurality of supporting blocks arranged on the base plate, each of which includes one or more penetration holes and on which the substrate is arranged; and an absorption member which is connected to the base plate and transmits an absorption force via the one or more penetration holes, such that the substrate and the plurality of supporting blocks are attached to each other.

### CROSS-REFERENCE TO RELATED PATENT APPLICATION

This application claims the benefit of Korean Patent Application No. 10-2011-0025880, filed on Mar. 23, 2011, in the Korean Intellectual Property Office, the disclosure of which is incorporated herein in its entirety by reference.

### BACKGROUND

1. Field

Embodiments described herein relate to a laser processing work table, and more particularly, to a work table for easily performing various types of laser processing.

2. Description of the Related Art

A laser beam is employed in laser processing in order to cut a substrate, which is an object to be processed, or to form a particular pattern on a substrate. Such laser processing is performed by arranging a substrate on a supporting member and irradiating a laser beam from above the substrate to a desired location.

### SUMMARY

According to an aspect of the present invention, there is provided a laser processing work table for processing a substrate by using a laser beam, the laser processing work table including a base plate; a plurality of supporting blocks arranged on the base plate, each of the supporting blocks including one or more penetration holes the supporting blocks being for arrangeably receiving the substrate; and an absorption member which may be connected to the base plate and transmits an absorption force via the one or more penetration holes, such that the substrate and the plurality of supporting blocks are attachable to each other.

The base plate may include a first surface of a porous material. The plurality of supporting blocks may be arranged on the first surface. The absorption force of the absorption member may be applied to the first surface.

An entirety of the base plate may be formed of a porous material.

The supporting blocks may be arranged on the base plate such that at least one gap may be formed between adjacent supporting blocks.

The at least one gap may be located such that when a processed portion is formed on the substrate by using the laser beam, the processed portion may correspond to the at least one gap.

One end of the one or more penetration holes may face the base plate. Another end of the one or more penetration holes may face the substrate. The absorption force of the absorption member may be applied to the substrate via the one or more penetration holes.

The supporting blocks may be formed of a porous material.

The absorption member may be connected to a vacuum pump.

The absorption member may be connected to a side surface of the base plate or to a surface of the base plate opposite a surface thereof facing the supporting blocks.

According to another aspect of the present invention, there is provided a method of installing a laser processing work table for processing a substrate by using a laser beam, the method including providing a base plate connected to an absorption member; arranging a plurality of supporting blocks on the base plate, arranging the substrate on the plurality of supporting blocks; and attaching the substrate and the plurality of supporting blocks to each other by applying an absorption force of the absorption member.

The absorption force of the absorption member may be applied after the supporting blocks are arranged on the base plate.

The plurality of supporting blocks may be manually arranged on the base plate.

The plurality of supporting blocks may be arranged on the base plate by an arranging member.

The arranging member may include a driving unit and a picker, and the arranging of the plurality of supporting blocks on the base plate may include picking up the plurality of supporting blocks via the picker; arranging the picker above desired locations; and putting down the plurality of supporting blocks at the desired locations of the base plate.

The picker may pick up the plurality of supporting blocks by applying a picker absorption force.

The driving unit may move linearly and may rotate.

### BRIEF DESCRIPTION OF THE DRAWINGS

The above and other features will become more apparent by describing in detail exemplary embodiments thereof with reference to the attached drawings in which:

FIG. 1 illustrates a schematic diagram showing laser processing performed by using a laser processing work table according to an embodiment;

FIG. 2 illustrates a schematic plan view of the laser processing work table of FIG. 1;

FIG. 3 illustrates a plan view of a base plate of the laser processing work table of FIG. 2;

FIG. 4 illustrates a sectional view taken along line IV-IV of FIG. 2;

FIG. 5 illustrates a schematic plan view of a laser processing work table according to another embodiment;

FIG. 6 illustrates a diagram showing portion B of FIG. 5 in closer detail; and

FIG. 7 illustrates a diagram showing an operation for installing the laser processing work table of FIG. 1.

### DETAILED DESCRIPTION

This application claims the benefit of Korean Patent Application No. 10-2011-0025880, filed on Mar. 23, 2011, in the Korean Intellectual Property Office, the disclosure of which is incorporated herein in its entirety by reference.

Hereinafter, the various aspects will be described in detail by explaining preferred embodiments with reference to the attached drawings.

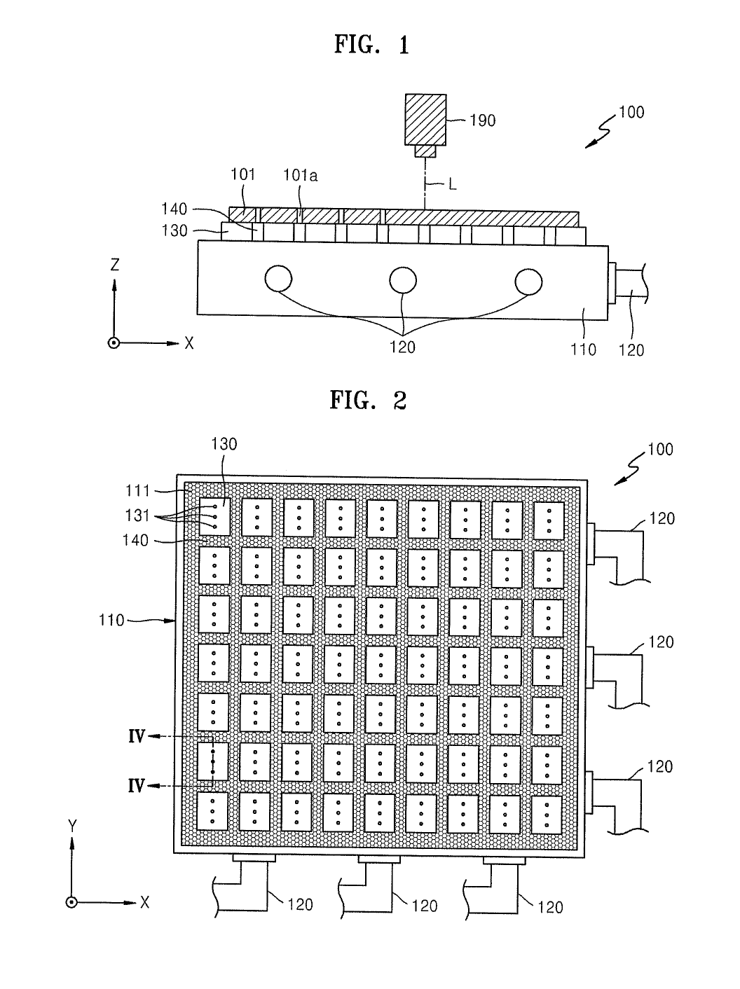

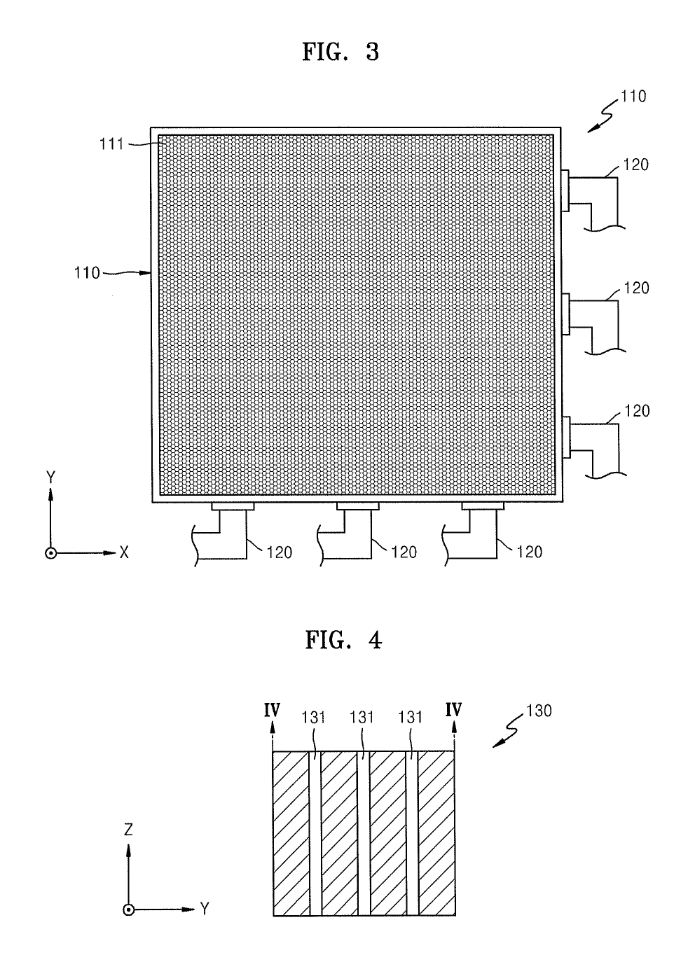

FIG. 1 is a schematic diagram showing laser processing performed by using a laser processing work table 100 according to an embodiment, and FIG. 2 is a schematic plan view of the laser processing work table 100 of FIG. 1. FIG. 3 is a plan view of a base plate 110 of the laser processing work table 100 of FIG. 2, and FIG. 4 is a sectional view taken along line IV-IV of FIG. 2.

Referring to FIGS. 1 through 4, the laser processing work table 100 includes the base plate 110, an absorption member 120, and a plurality of supporting blocks 130.

Referring to FIG. 1, laser processing by using the laser processing work table 100 according to the present embodiment will be briefly described.

The plurality of supporting blocks 130 are arranged on the base plate 110, and a substrate 101, which is an object to be laser processed, is arranged on the plurality of supporting blocks 130. A laser light source 190 for irradiating a laser beam L is arranged above the substrate 101. Types and output power of the laser beam L may vary according to types of laser processing and types of the substrate 101.

Next, a processed portion 101a is formed on the substrate 101 by using the laser beam L. The processed portion 101a is formed to penetrate the substrate 101. The processed portion 101a may be a patterned portion of the substrate 101 or a cut portion of the substrate 101.

A gap 140 is formed between adjacent blocks of the plurality of supporting blocks 130 arranged below the substrate 101, and the processed portion 101a of the substrate 101 corresponds at least to the gap 140. A part of the laser beam L irradiated to the substrate 101 continues traveling after the processed portion 101 is formed. Since this part of the laser beam L travels into the gap 140, the laser beam L does not contact the supporting block 130.

The laser processing work table 100 according to the present embodiment will be described below in detail. The base plate 110 includes a first surface 111 formed of a porous material. In detail, the first surface 111 may be formed of a porous sintered material, and may have a honeycomb structure.

The base plate 110 may have a black-based color to reduce reflection of the laser beam L.

The absorption member 120 is connected to the base plate 110 and a vacuum pump (not shown). Therefore, the absorption member 120 transmits an absorption force to the first surface 111 of the base plate 110.

For the absorption member 120 to transmit the absorption force to the first substrate 111 of the base plate 110, the base plate 110 may have any of various shapes. For example, the entire base plate 110 may be formed of the same porous material as the first surface 111. However, the present invention is not limited thereto. For example, the base plate 110 may be formed to have a box-like shape, and an empty space may be formed below the first surface 111, so that the absorption force of the absorption member 120 may be transmitted to the first surface 111 via the empty space.

The absorption member 120 may be arranged at any of various locations. Although the absorption member 120 is arranged only at a side of the base plate 110 in the present embodiment, the present invention is not limited thereto. For example, the absorption member 120 may be arranged on the bottom surface of the base plate 110, so that the absorption force of the absorption member 120 may be directly transmitted to the first surface 111.

The supporting blocks 130 are arranged on the base plate 110. In detail, the plurality of supporting blocks 130 may be arranged on the first surface 111. The supporting blocks 130 are spaced apart from each other, and the gap 140 is formed between adjacent supporting blocks 130. The supporting blocks 130 may be arranged on the base plate 110 in any of various shapes. A shape and a size of the gap 140 may vary according to types of laser processing operations.

As described above, the processed portion 101a of the substrate 101, which is an object to be processed, is arranged at least in the gap 140. In detail, all of the processed portions 101a shall overlap the gap 140. Here, the gap 140 may be formed to correspond to a portion other than the processed portion 101a.

The supporting block 130 includes one or more penetration holes 131. An end of the penetration hole 131 faces the first surface 111 of the base plate 110, whereas the other end of the penetration hole 131 faces the substrate 101. An absorption force of the absorption member 120 is transmitted to the substrate 101 via the penetration hole 131. The absorption force of the absorption member 120 is transmitted to the first surface 111, and then is transmitted to the bottom surface of the substrate 101 via the penetration hole 131 of the supporting block 130.

The supporting block 130 and the base plate 110 may be attached to each other as close as possible without a gap therebetween.

The substrate 101 is fixed to the plurality of supporting blocks 130 by using the absorption force of the absorption member 120. Adhesiveness between the substrate 101 and the supporting block 130 may be controlled by controlling the absorption force of the absorption member 120. For example, an absorption force applied to the first surface 111 of the base plate 110 may be 6 bar or greater, whereas an absorption force applied to the supporting block 130 may be 3 bar or greater. However, the present invention is not limited thereto, and the absorption force may be configured in various manners according to a material constituting the substrate 101 and laser processing conditions.

Furthermore, the absorption force of the absorption member 120 may not be applied while the supporting blocks 130 are arranged on the base plate 110, and may be applied after the supporting blocks 130 are arranged on the base plate 110 and the substrate 101 is aligned and arranged on the supporting block 130.

According to the laser processing work table 100 according to the present embodiment, damages to the supporting blocks 130 which contact the bottom surface of the substrate 101, which is an object to be processed, may be prevented, and thus, the supporting blocks 130 may be permanently used. If laser processing were to be performed using a supporting member that has the same size as or is larger than the substrate 101 and is arranged below the substrate 101, the supporting member may be damaged in correspondence to a shape of the processed portion 101a of the substrate 101. As a result, efficiency of laser processing may be significantly reduced. However, in the present embodiment, at least the processed portion 101a is arranged to correspond to the gap 140 of the supporting block 130, so that damages to the supporting block 130 by the laser beam L are prevented.

Regarding the laser processing work table 100 according to the present embodiment, the substrate 101 and the supporting blocks 130 are fixed to each other by using the absorption member 120. Therefore, the supporting block 130 may be easily arranged in various manners. In a case of performing a second laser processing operation for forming another pattern on the substrate 101 or for cutting the substrate 101 after the supporting blocks 130 are arranged for a first laser processing operation for forming a particular pattern on the substrate 101 and the first laser processing operation is performed, the second laser processing operation may be performed after the supporting blocks 130 are rearranged and the substrate 101 and the supporting blocks 130 are fixed by using the absorption member 120. Therefore, efficiency of the overall laser processing operation may be improved, and various types of laser processing operations may be easily performed.

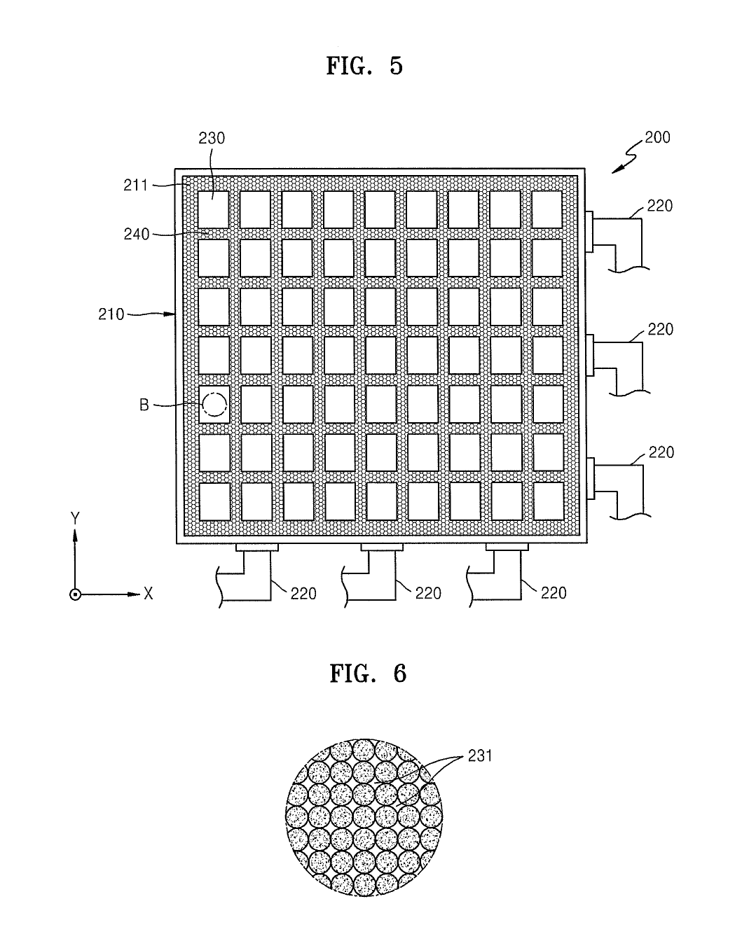

FIG. 5 is a schematic plan view of a laser processing work table 200 according to another embodiment, and FIG. 6 is a diagram showing portion B of FIG. 5 in closer detail.

The laser processing work table 200 according to the present embodiment includes a base plate 210, an absorption member 220, and a plurality of supporting blocks 230.

The base plate 210 includes a first surface 211 formed of a porous material. In detail, the first surface 211 may be formed of a porous sintered material and may have a honeycomb structure. The base plate 210 may have a black-based color

The absorption member 220 is connected to the base plate 210 and a vacuum pump (not shown). Therefore, the absorption member 220 transmits an absorption force to the first surface 211 of the base plate 210.

For the absorption member 220 to transmit the absorption force to the first substrate 211 of the base plate 210, the base plate 210 may have any of various shapes. For example, the entire base plate 210 may be formed of the same porous material as the first surface 211. However, the present invention is not limited thereto. For example, the base plate 210 may be formed to have a box-like shape, and an empty space may be formed below the first surface 211, so that the absorption force of the absorption member 220 may be transmitted to the first surface 211 via the empty space.

The absorption member 220 may be arranged at any of various locations. Although the absorption member 220 is arranged only at a side of the base plate 210 in the present embodiment, the embodiments are not limited thereto. For example, the absorption member 220 may be arranged on the bottom surface of the base plate 210, so that the absorption force of the absorption member 220 may be directly transmitted to the first surface 211.

The supporting blocks 230 are arranged on the base plate 210. In detail, the plurality of supporting blocks 230 may be arranged on the first surface 211. The supporting blocks 230 are apart from each other, and the gap 240 is formed between adjacent supporting blocks 230. The supporting blocks 230 may be arranged on the base plate 210 in any of various shapes. A shape and a size of the gap 240 may vary according to types of laser processing operations.

The supporting blocks 230 are formed of a porous material and include a plurality of penetrated portions 231. An absorption force is transmitted to a substrate (not shown), which is an object to be processed, via the penetrated portions 231. The absorption force of the absorption member 220 is transmitted to the first surface 211, and then is transmitted to the bottom surface of the substrate (not shown) via the penetrated portions 231 of the supporting blocks 230.

The substrate (not shown) is fixed to the plurality of supporting blocks 230 by the absorption force of the absorption member 220. Here, adhesiveness between the substrate (not shown) and the supporting blocks 230 may be controlled by controlling the absorption force of the absorption member 220. For example, the absorption force applied to the first surface 211 of the base plate 210 may be 6 bar or greater, whereas the absorption force applied to the supporting block 230 may be 3 bar or greater. However, the embodiments are not limited thereto, and absorption force may be configured in various manners according to a material constituting the substrate 201 and operation conditions.

According to the laser processing work table 200 according to the present embodiment, damages to the supporting blocks 230 which contact the bottom surface of the substrate 201, which is an object to be processed, may be prevented, and thus, the supporting blocks 230 may be permanently used.

Furthermore, in the laser processing work table 200 according to the present embodiment, the substrate (not shown) and the supporting blocks 230 are fixed to each other by using the absorption member 220. Therefore, the absorption member 220 may be easily arranged in various manners. In a case of performing a second laser processing operation for forming another pattern on the substrate (not shown) or for cutting the substrate (not shown) after the supporting blocks 230 are arranged for a first laser processing operation for forming a particular pattern on the substrate (not shown) and the first laser processing operation is performed, the second laser processing operation may be performed after the supporting blocks 230 are rearranged and the substrate (not shown) and the supporting blocks 230 are fixed by using the absorption member 220. Therefore, efficiency of overall laser processing operation may be improved, and various types of laser processing operations may be easily performed.

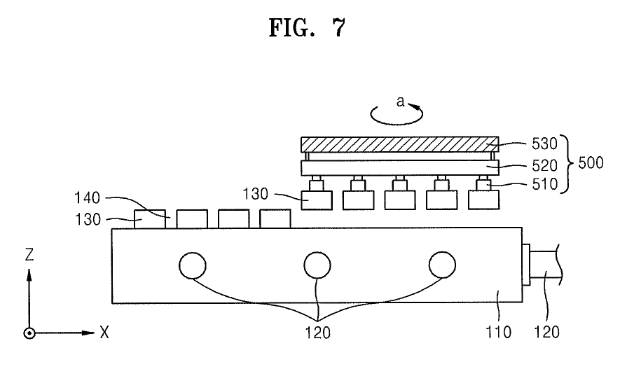

FIG. 7 is a diagram showing an operation for installing the laser processing work table 100 of FIG. 1. FIG. 7 shows an arranging member 500 for arranging the plurality of supporting block 130 on the base plate.

The arranging member 500 includes a picker 510, a main body 520, and a driving unit 530.

As described above, the plurality of supporting blocks 130 may be arranged on the base plate 110 in various manners according to a processed portion of an object to be processed. Although the supporting blocks 130 may be arranged manually, the arranging member 500 may be used for efficiency and safety of arranging the supporting blocks.

The picker 510 of the arranging member 500 picks up one or more of the supporting blocks 130. The picker 510 may be connected to a vacuum pump for obtaining an absorption function so that the picker 510 may easily pick up or put down the supporting blocks 130.

The driving unit 530 moves the picker 510, such that the picker 510 picks up the supporting block 130 and arranges the supporting blocks 130 at desired locations on the base plate 110. To move the picker 510, the driving unit 530 may move in a 2-dimensional direction, that is, in the x-axis direction of FIG. 7 and a direction perpendicular thereto, uni-directionally or back and forth. Furthermore, the driving unit 530 may rotate for precise movement of the picker 510. The driving unit 530 may rotate in the direction a shown in FIG. 7.

The driving unit 530 may also move in the z-axis direction, such that the picker 510 safely puts down the supporting block 130 on the base plate 110.

Although the driving unit 530 and main body 520 are separated from each other, the main body 520 may also function as the driving unit 530.

As described above, various types of laser processing may be easily performed by using a laser processing work table according to the present invention.

By way of summation and review, during laser processing, a laser beam penetrates a cut portion and a patterned portion of a substrate and may damage a surface of a supporting member that contacts the bottom of the substrate. Particularly, in the case of laser processing a plurality of substrates in different patterns, it may be necessary to replace a damaged supporting member. Therefore, there is a limit in performing various types of laser processing. According to embodiments disclosed herein, a work table is provided that may circumvent such situations and that may easily perform various types of laser processing.

While the present invention has been particularly shown and described with reference to exemplary embodiments thereof, it will be understood by those of ordinary skill in the art that various changes in form and details may be made therein without departing from the spirit and scope as defined by the following claims.

What is claimed is:

1. A laser processing work table for processing a substrate by using a laser beam, the laser processing work table comprising:
a base plate;
a plurality of supporting blocks arranged on the base plate, each of the supporting blocks including one or more penetration holes, the supporting blocks being for arrangeably receiving the substrate; and
an absorption member which is connected to the base plate and which transmits an absorption force via the one or more penetration holes, such that the substrate and the plurality of supporting blocks are attachable to each other.

2. The laser processing work table of claim 1, wherein:
the base plate includes a first surface of a porous material,
the plurality of supporting blocks are arranged on the first surface; and
the absorption force of the absorption member is applied to the first surface.

3. The laser processing work table of claim 1, wherein an entirety of the base plate is formed of a porous material.

4. The laser processing work table of claim 1, the supporting blocks are arranged on the base plate such that at least one gap is formed between adjacent supporting blocks.

5. The laser processing work table of claim 4, wherein the at least one gap is located such that, when a processed portion is formed on the substrate by using the laser beam, the processed portion corresponds to the at least one gap.

6. The laser processing work table of claim 1, wherein:
one end of the one or more penetration holes faces the base plate,
another end of the one or more penetration holes faces the substrate, and
the absorption force of the absorption member is applied to the substrate via the one or more penetration holes.

7. The laser processing work table of claim 1, wherein the supporting blocks are formed of a porous material.

8. The laser processing work table of claim 1, wherein the absorption member is connected to a vacuum pump.

9. The laser processing work table of claim 1, wherein the absorption member is connected to a side surface of the base plate or to a surface of the base plate opposite a surface thereof facing the supporting blocks.

10. A method of installing a laser processing work table for processing a substrate by using a laser beam, the method comprising:
providing a base plate connected to an absorption member;
arranging a plurality of supporting blocks on the base plate,
arranging the substrate on the plurality of supporting blocks; and
attaching the substrate and the plurality of supporting blocks to each other by applying an absorption force of the absorption member.

11. The method of claim 10, wherein the absorption force of the absorption member is applied after the plurality of supporting blocks are arranged on the base plate.

12. The method of claim 10, wherein the plurality of supporting blocks are manually arranged on the base plate.

13. The method of claim 10, wherein the plurality of supporting blocks are arranged on the base plate by an arranging member.

14. The method of claim 13, wherein:
the arranging member includes a driving unit and a picker, and
the arranging of the plurality of supporting blocks on the base plate includes:
picking up the plurality of supporting blocks via the picker;
arranging the picker above desired locations; and
putting down the plurality of supporting blocks at the desired locations of the base plate.

15. The method of claim 14, wherein the picker picks up the plurality of supporting blocks with a picker absorption force.

16. The method of claim 14, wherein the driving unit moves linearly and rotates.
